(19) United States
(12) Patent Application Publication
(10) Pub. No.: US 2013/0278925 A1
(43) Pub. Date: Oct. 24, 2013

(54) DETECTING DEVICE AND METHOD FOR SUBSTRATE

(71) Applicant: Wen-Da Cheng, Shenzhen (CN)

(72) Inventor: Wen-Da Cheng, Shenzhen (CN)

(21) Appl. No.: 13/582,165

(22) PCT Filed: May 15, 2012
(86) PCT No.: PCT/CN12/75489

§ 371 Date: Aug. 31, 2012

(30) Foreign Application Priority Data
Apr. 19, 2012 (CN) 201210118199.9

(51) Int. Cl. G01N 21/88

(52) U.S. Cl. CPC G01N 21/8851
USPC 356/237.5

(57) ABSTRACT

A detecting method for a substrate includes the following steps: positioning the substrate; optically scanning the substrate and determining whether there is any defect on the substrate, if there is at least one defect on the substrate, determining the position of the at least one defect; obtaining a plurality of size images of a plurality of measuring areas of the substrate and transferring the size images; and calculating a width of each line on the substrate, and simultaneously obtaining a defection image of the at least one defect. The present disclosure further provides a detecting device for the substrate. With the detecting method and device, the defect detecting and measurement of the width of each line can be carried out simultaneously, which reduces the manufacturing time of the substrate and improves the manufacturing efficiency thereof.

### BACKGROUND

1. Technical Field

The present disclosure relates to liquid crystal displaying technologies, and particularly, to a detecting device and a detecting method for a substrate.

2. Description of Related Art

In manufacturing process of a thin film transistor (TFT) substrate of a liquid crystal panel, many detecting mechanisms are employed to detect the TFT substrate. In the detecting process, it is often required to detect whether there is any defect on the substrate and to determine the widths of lines of the substrate. Generally, the substrate is at first transferred to a detecting device for a first optical positioning and scanning, during which images of defects on the substrate are obtained, the defects then are detected according to the obtained image; secondly, the substrate is transferred to a measuring device for a second optical positioning, images of measuring areas of the substrate then are obtained to allow the width of each line to be measured according to the obtained image. In this detecting method, it requires to transfer the substrate to the detecting device and further to the measuring device, and to position the substrate twice for carrying out the defects detecting and widths measurement of the lines. Additionally, the defects detecting and the widths measurement of the lines are carried out in turn. Therefore, it requires much time to finish the manufacturing process of the substrate, which reduces the manufacturing efficiency of the substrate.

### SUMMARY

The present disclosure provides a detecting method for a substrate. The detecting method includes: positioning the substrate; optically scanning the substrate and determining whether there is any defect on the substrate, if there is at least one defect on the substrate, determining the position of the at least one defect; obtaining a number of size images of a number of measuring areas of the substrate and transferring the size images; and calculating a width of each line on the substrate, and simultaneously obtaining a defection image of the at least one defect, and determining the type of the at least one defect according to the defection image.

Preferably, the step of positioning the substrate includes: providing a number of positioning marks on four corners or edges of the substrate, and determining the position of the substrate relative to a detecting device according to the positions of the positioning marks on the substrate.

Preferably, the step of obtaining a number of size images of a number of measuring areas and transferring the size images includes: providing an obtaining unit for obtaining the size images of the measuring areas of the substrate; and providing a transferring unit for transferring the size images to a calculating module such that the calculating module can calculate the width of each line on the substrate.

Preferably, the step of calculating the width of each line on the substrate includes: receiving the size images; and calculating the width of each line of the measuring areas according to the received size images and settings of the obtaining module when the size images are obtained.

Preferably, the settings includes the magnification factor between the size images and the true sizes of the measuring areas when the obtaining module obtains the size images

Preferably, the step of calculating the width of each line of the measuring areas according to the received size images and settings of the obtaining module when the size images are obtained includes: calculating the width of each line according to the width of the line in the size images and the magnification factor between the size images and the true sizes of the measuring areas when the obtaining module obtains the size images.

Preferably, the step of obtaining a defection image of the at least one defect, and determining the type of the at least one defect according to the defection image includes: an obtaining module obtaining the defection image of the at least one defect at the position of the at least one detect, and transferring the defection image to an analyzing module; and an analyzing module receiving the defection image and analyzing the defection image for determining the type of the at least one defect according to the defection image.

The present disclosure further provides another detecting method for a substrate. The detecting method includes: positioning the substrate; optically scanning the substrate to determine whether there is any defect on the substrate, and if there is at least one defect on the substrate, determining the position of the at least one defect; obtaining size images of measuring areas of the substrate and transferring the size images; and calculating a width of each line on the substrate and simultaneously obtaining a defection image of the at least one defect.

Preferably, the step of positioning the substrate includes: providing a number of positioning marks on four corners or edges of the substrate, and determining the position of the substrate relative to a detecting device according to the positions of the positioning marks on the substrate.

Preferably, the step of obtaining a number of size images of a number of measuring areas and transferring the size images includes: an obtaining unit obtaining the size images of the measuring areas of the substrate; and a transferring unit transferring the size images to a calculating module such that the calculating module can calculate the width of each line on the substrate.

Preferably, the step of calculating the width of each line on the substrate includes: receiving the size images; and calculating the width of each line of the measuring area according to the received size images and settings of the obtaining module when the size images are obtained.

Preferably, the settings include the magnification factor between the size images and the true sizes of the measuring areas when the obtaining module obtains the size images.

Preferably, the step of calculating the width of each line of the measuring areas according to the received size images and settings of the obtaining module when the size images are obtained includes: calculating the width of each line according to the width of the line in the size images and the magnification factor.

Preferably, the step of obtaining a defection image of the at least one defect, and determining the type of the at least one defect according to the defection image includes: the obtaining module obtaining the defection image of the at least one defect at the position of the at least one detect, and transferring the defection image to an analyzing module; and the analyzing module receiving the defection image and analyzing the defection image for determining the type of the at least one defect according to the defection image.

The present disclosure further provides a detecting device for a substrate. The detecting device includes a positioning module for positioning the substrate, a scanning module for optically scanning the substrate, determining whether there is any defect on the substrate, and if there is at least one defect on the substrate, determining the position of the at least one defect; an obtaining module for obtaining a number of size images of a number of measuring areas of the substrate or a defection image of the at least one defect, and transferring the size images or the defection image; and a calculating module for calculating a width of each line on the substrate.

Preferably, the obtaining module includes an obtaining unit and a transferring unit, the obtaining unit is used for obtaining the size images of the measuring areas or the defection image of the at least one defect, and the transferring unit is used for transferring the size images or the defection image.

Preferably, the calculating module is used for receiving the size images transferred from the transferring unit, and calculating the width of each line of the measuring areas according to the size images and settings of the obtaining unit when the size images are obtained.

Preferably, the obtaining module includes a first obtaining module for obtaining and transferring the size images and a second obtaining module for obtaining and transferring the defection image.

Preferably, the first obtaining module includes a first obtaining unit for obtaining the size images and a first transferring unit for transferring the size images, the second obtaining module includes a second obtaining unit for obtaining the defection image and a second transferring unit for transferring the defection image.

Preferably, the detecting device further includes an analyzing module for determining the type of the at least one defect according to the defection image.

In the detecting method of the present disclosure, after the substrate is transferred into the detecting device, the substrate is at first optically scanned for determining whether there is any defect on the substrate and for determining the position of the defect if there is at least one defect on the substrate; subsequently, the size images of the measuring areas of the substrate are obtained; after that, the width of each line on the substrate is calculated according to the size images and the defection image are simultaneously obtained. In the process, the substrate is positioned once for carrying out the calculation of the width of each line on the substrate and the optical detecting of the defect. Additionally, the defection image can be obtained simultaneously with the calculation of the width of the each line, which reduces the time required for detecting the substrate, reduces the manufacturing time of the substrate, and further improves the manufacturing efficiency of the substrate.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a flow chart of a detecting method for a substrate according to a first embodiment of the present disclosure;

FIG. 2 is a flow chart of a step of obtaining size images of measuring areas of the substrate of the detecting method of FIG. 1;

FIG. 3 is a flow chart of a detecting method for a substrate according to a second embodiment of the present disclosure;

FIG. 4 is a schematic view of a detecting device according to a first embodiment of the present disclosure;

FIG. 5 is a schematic view of an obtaining module of the detecting device of FIG. 4;

FIG. 6 is a schematic view of a detecting device according to a second embodiment of the present disclosure.

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

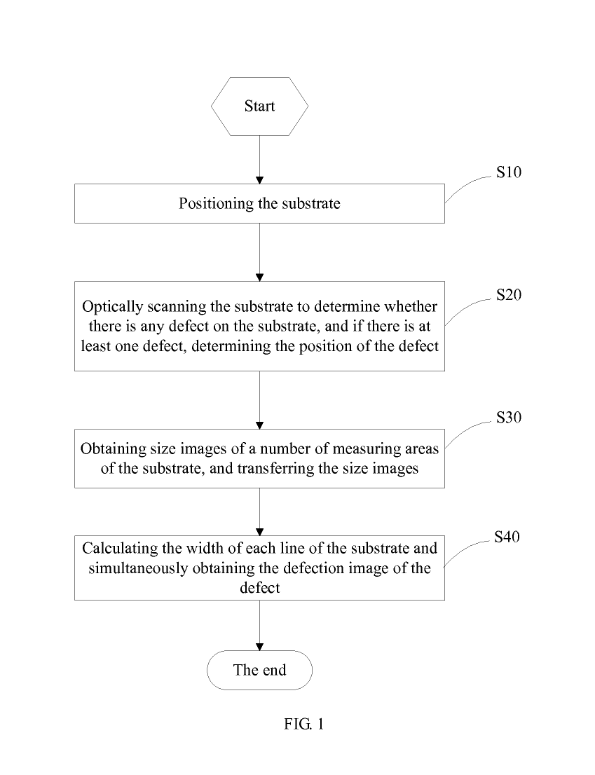

Referring to FIG. 1, a detecting method for a substrate, in accordance with a first embodiment, is shown. The detecting method includes the following steps:

Step S10, positioning the substrate. The substrate is transferred to a detecting device for carrying out optical defects detecting and calculation of a width of each line. The substrate is positioned by a positioning module of the detecting device. Four corners or edges of the substrate are respectively marked with positioning marks respectively substantially shaped as “+”. After the substrate enters the detecting device, the positioning module positions the substrate by determining the position of the substrate relative to the detecting device according to the positioning marks on the substrate.

Step S20, optically scanning the substrate to determine whether there is any detect on the substrate, and if there is at least one defect, determining the position of the defect. In the embodiment, a scanning module is provided for optically scanning the substrate for determining whether there is any defect on the substrate. If there is at least one defect on the substrate, the position of the defect is determined after the optical scanning. If there are no defects being detected, the next step is implemented.

Step S30, obtaining size images of a number of measuring areas of the substrate, and transferring the size images. The substrate may be provided with a number of the measuring areas. Firstly, the measuring area whose size images needs to be obtained is determined. Then, according to the position of the substrate relative to the detecting device and the position of the measuring area on the substrate, an obtaining module is moved to correspond to the measuring area for obtaining the size image of the corresponding measuring area. The size image then is transferred to a calculating module such that the widths of the lines of the substrate can be calculated according to the size images.

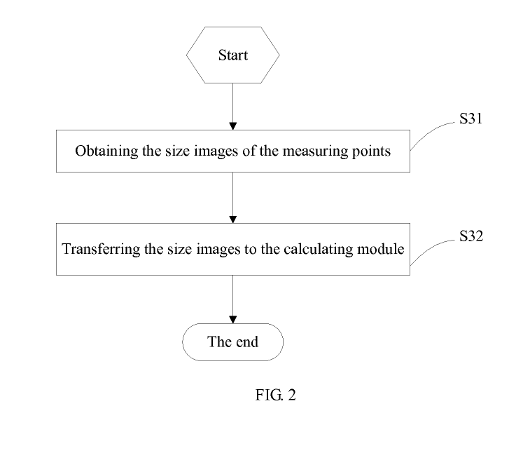

Referring also to FIG. 2, specifically, the step S30 includes the following steps:

Step S31, obtaining the size images of the measuring areas. In the embodiment, a number of the measuring areas are provided on the substrate for accurate calculation of the width of each line on the substrate. The obtaining module is capable of obtaining a number of the size images respectively corresponding to the measuring areas. The lines of the substrate include signal lines and data lines, and each measuring area may be an area including the data lines or signal lines. Each size image obtained by the obtaining module is the image of the area including the data lines or the signal lines.

Step S32, transferring the size images to the calculating module to allow the calculating module to calculate the width of each line. The obtaining module transfers the obtained size images to the calculating module. Since the size images correspond to the measuring areas respectively, thus, after each size image is received, the calculating module is capable of calculating the widths of the lines of the measuring area according to the size image.

Step S40, calculating the width of each line and simultaneously obtaining the defection image of the defect. The calculating module receives the size images from the obtaining module and calculating the width of each line according to the size images and simultaneously obtaining the defection image of the defects on the substrate.

The calculating module calculates the width of the corresponding line of the measuring area, according to the size images and the settings of the obtaining module when the size images are obtained. In the embodiment, after the size images are received, the calculating module calculates the widths of the signal lines or the data lines according to the widths of the lines on the size images and the magnification factor between the size images and the measuring areas. Since the data lines and signal lines of the substrate are small-sized, a focal distance of the obtaining module is adjusted when obtaining the size images for magnifying the data lines and the signal lines of the substrate. Thus, when calculating the width of each line, the calculating module needs to obtain the magnification factor and the widths of the data lines and the signal lines on the size images for calculating the true widths of the data lines and the signal lines.

At the same time, the obtaining module is moved to correspond to the defect on the substrate determined in the step of S20 for obtaining the defection image of the defect. The defection image can further be used for determining the type of the defect, thus, the defect can be repaired.

It is noted that in other embodiments, the obtaining module may include a first obtaining module and a second obtaining module. The first obtaining module is used for obtaining and transferring the size images, and the second obtaining module is used for obtaining and transferring the defection image. The first obtaining module includes a first obtaining unit for obtaining the size images of the measuring areas and a first transferring unit for transferring the size images to the calculating module. The second obtaining module includes a second obtaining unit for obtaining the defection image of the defect and a second transferring unit for transferring the defection image.

It is noted that in the embodiment, if no defects are detected after the optical scanning, the calculating module calculates the width of each line with the omission of the step of obtaining the defection image.

In the detecting method of the present disclosure, after the substrate is transferred into the detecting device, the substrate is at first positioned for determining the position of the substrate relative to the detecting device; the substrate then is optically scanned for determining whether there is any defect on the substrate and for determining the position of the defect if there is at least one defect on the substrate; subsequently, the size images of the measuring areas of the substrate are obtained; after that, the width of each line on the substrate is calculated according to the size images and the defection image are simultaneously obtained. In the process, the substrate is positioned once for carrying out the calculation of the width of each line on the substrate and the optical detecting of the defect. Additionally, the defection image can be obtained simultaneously with the calculation of the width of the each line.

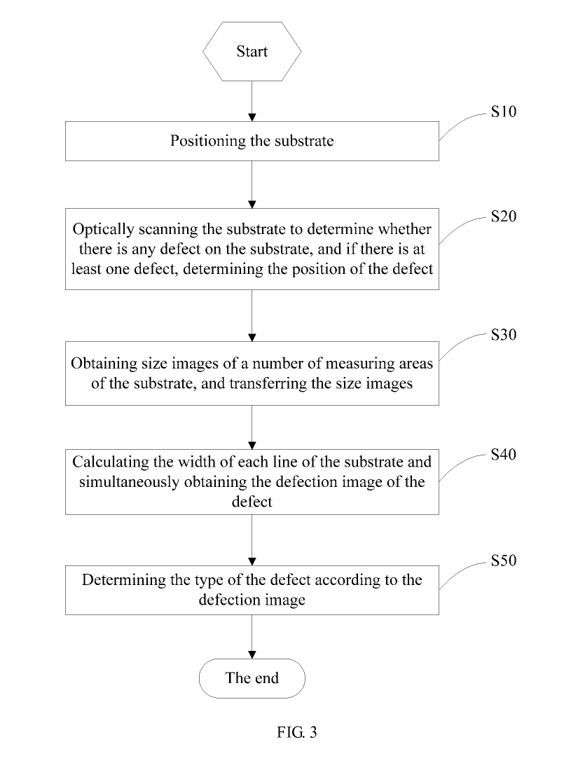

Referring to FIG. 3, a detecting method for the substrate, in accordance with a second embodiment, is provided. The detecting method of the second embodiment is similar to that of the first embodiment, and the difference therebetween lies in that, the detecting method of the second embodiment further includes a step S50 after the step S40: determining the type of the defect according to the defection image. After the defection image is obtained by the obtaining module, the defection image is further transferred to an analyzing module. The analyzing module analyzes the defection image for determining the type of the defect after receiving the defection image. Thus, the defect can be repaired in the following process.

The defection image of the defect in this embodiment is transferred to the analyzing module to allow the analyzing module to analyze the defection image and determine the type of the defect. Therefore, the defect can be repaired in the following process, which reduces the time required for detecting the substrate and further reduce the manufacturing time of the substrate.

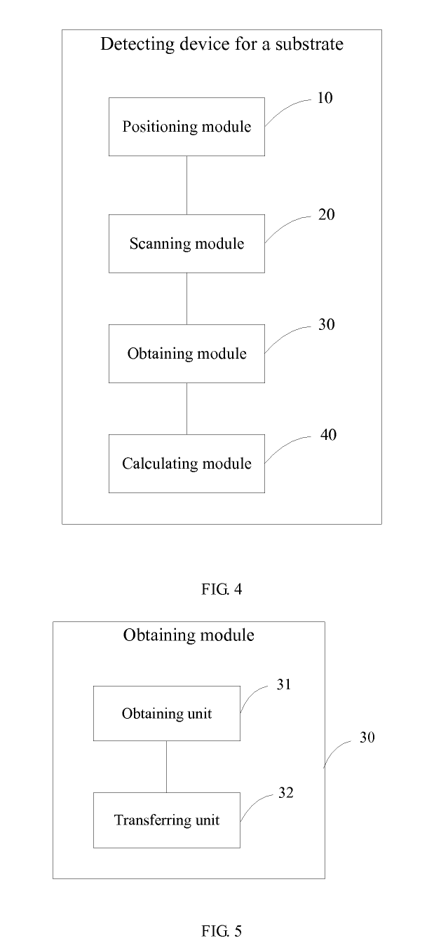

Referring to FIG. 4, a detecting device, in accordance with a first embodiment of the present disclosure, is provided. The detecting device includes a positioning module 10, a scanning module 20, an obtaining module 30, and a calculating module 40. The positioning module 10 is used for positioning the substrate. The scanning module 20 is used for optically scanning the substrate to determine whether there is any defect on the substrate. The scanning module 20 is capable of determining the position of the defect if there is at least one defect on the substrate. The obtaining module 30 is used for obtaining the size images of the measuring areas of the substrate or the defection image of the defect, and outputting the obtained size images or the defection image. The calculating module 40 is used for calculating the width of each line.

After the substrate enters the detecting device, the positioning module 10 positions the substrate. The substrate is provided with a number of positioning marks respectively substantially “+”shaped at the four corners or edges thereof. After the substrate enters the detecting device, the positioning module 10 positions the substrate by determining the relative position between the substrate and the detecting device according to the positioning marks on the substrate.

The scanning module 20 scans the substrate for determining whether there is any defect on the substrate. If there is at least one defect on the substrate, the scanning module 20 further determines the position of the defect.

There are a number of measuring areas, and the obtaining device 30 is moved to correspond to the measuring areas for obtaining the size images of the measuring areas. The obtaining device 30 then transfers the size images to the calculating module 40 such that the calculating module 40 can calculate the width of each line on the substrate according to the size images.

Referring to FIG. 5, the obtaining module of the first embodiment includes an obtaining unit 31 and a transferring unit 32. The obtaining unit 31 is used for obtaining the size images of the measuring areas or the defection image of the defect. The transferring unit 32 is used for transferring the size images or the defection image.

In the embodiment, the measuring areas are provided on the substrate for accurately obtaining the width of each line. The obtaining unit 31 obtains the size images respectively corresponding to the measuring areas. The lines of the substrate include signal lines and data lines, and each measuring area is an area including the data lines or the signal lines. The obtaining unit 31 obtains the image of each area including the data lines or the signal lines.

The transferring unit 32 transfers the size images to the calculating module 40. Since the size images respectively correspond to the measuring areas, after each size image is received, the calculating module 40 is capable of calculating the width of the line of the measuring area corresponding to the size image after receiving the size image.

The calculating module 40 is used for receiving the size images from the transferring unit 32, and calculating the width of each line on the substrate. The calculating module 40 calculates the width of the corresponding line of the measuring area according to the size images and the settings of the obtaining unit 31 when the size images are obtained. In the embodiment, after the size images is received, the calculating module 40 calculates the width of the signal line or the data line according to the width of each line on the size images and the magnification factor between the size images and the true sides of measuring areas. Since the data lines and signal lines of the substrate are small-sized, a focal distance of the obtaining unit 31 is adjusted when obtaining the size images for magnifying the data lines and the signal lines of the substrate. Thus, when calculating the width of each line, the calculating module 40 needs to obtain the magnification factor and the widths of the data lines and the signal lines on the size images for calculating the true width of the data lines and the signal lines.

At the same time, the obtaining module 30 is moved to correspond to the position of the defect on the substrate determined by the scanning module 20 for obtaining the defection image of the defect.

The positioning module 10 is capable of positioning the substrate for determining the position of the substrate relative to the detecting device; the scanning module 20 is capable of optically scanning the substrate for determining whether there is any defect on the substrate and for determining the position of the defect if there is at least one defect on the substrate; the obtaining module 30 is capable of obtaining the size images of the measuring areas of the substrate and the defection image, and the calculating module 40 is capable of calculating the width of each line on the substrate according to the size images. Thus, the substrate needs only to be positioned once for carrying out the calculation of the width of each line and the optical detecting of defect. Additionally, the defection image can be obtained simultaneously with the calculation of the width of the each line, which reduces the time required for detecting the substrate, reduces the manufacturing time of the substrate, and further improves the manufacturing efficiency of the substrate.

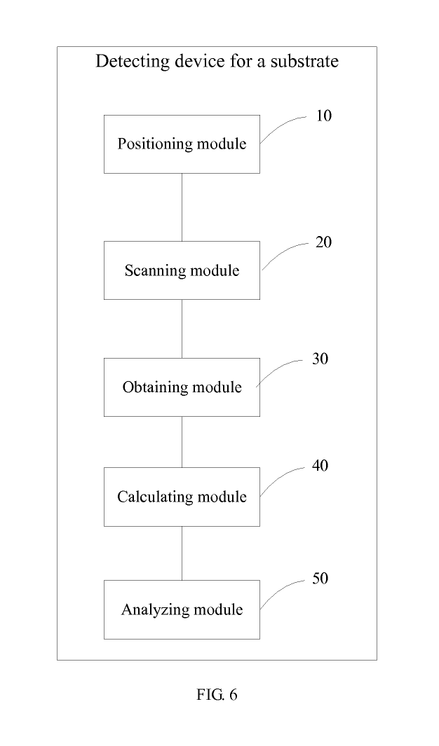

Referring to FIG. 6, a detecting device, in accordance with a second embodiment, is shown. The detecting device of the second embodiment is similar to that of the first embodiment, and the difference therebetween lies in that, the detecting device of this embodiment further includes an analyzing module 50 for determining the type of the defect.

The obtaining module 30 transfers the defection image to the analyzing module 50 after obtaining the defection image. The analyzing module 50 receives the defection image and analyzes the detection image for determining the type of the defect, thus, the defect can be repaired in the following process.

The defection image of the defect in this embodiment is transferred to the analyzing module 50 after obtained by the obtaining module 30, thus, the analyzing module 50 is capable of analyzing the defection image and determining the type of the defect after the defection image is received. Therefore, the defect can be repaired in the following process, which reduces the time required for detecting the substrate and further reduce the manufacturing time of the substrate.

In other embodiments, the obtaining module 30 includes a first obtaining module for obtaining and transferring the size images and a second obtaining module for obtaining and transferring the defection image. The first obtaining module includes a first obtaining unit for obtaining the size images and a first transferring unit for transferring the size images. The second obtaining module includes a second obtaining unit for obtaining the defection image and a second transferring unit for transferring the defection image.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A detecting method for a substrate, comprising:
positioning the substrate;
optically scanning the substrate and determining whether there is any defect on the substrate, if there is at least one defect on the substrate, determining the position of the at least one defect;
obtaining a plurality of size images of a plurality of measuring areas of the substrate and transferring the size images; and
calculating a width of each line on the substrate, and simultaneously obtaining a defection image of the at least one defect, and determining the type of the at least one defect according to the defection image.

2. The detecting method as claimed in claim 1, wherein the step of positioning the substrate comprises:
providing a plurality of positioning marks on four corners or edges of the substrate, and determining the position of the substrate relative to a detecting device according to the positions of the positioning marks on the substrate.

3. The detecting method as claimed in claim 2, wherein the step of obtaining a plurality of size images of a plurality of measuring areas and transferring the size images comprises:
providing an obtaining unit for obtaining the size images of the measuring areas of the substrate; and
providing a transferring unit for transferring the size images to a calculating module such that the calculating module can calculate the width of each line on the substrate.

4. The detecting method as claimed in claim 3, wherein the step of calculating the width of each line on the substrate comprises:
receiving the size images; and
calculating the width of each line of the measuring areas according to the received size images and settings of the obtaining module when the size images are obtained.

5. The detecting method as claimed in claim 4, wherein the settings comprise the magnification factor between the size images and the true sizes of the measuring areas when the obtaining module obtains the size images.

6. The detecting method as claimed in claim 5, wherein the step of calculating the width of each line of the measuring areas according to the received size images and settings of the obtaining module when the size images are obtained comprises: calculating the width of each line according to the width of the line in the size images and the magnification factor between the size images and the true sizes of the measuring areas when the obtaining module obtains the size images.

7. The detecting method as claimed in claim 1, wherein the step of obtaining a defection image of the at least one defect, and determining the type of the at least one defect according to the defection image comprises:
an obtaining module obtaining the defection image of the at least one defect at the position of the at least one detect, and transferring the defection image to an analyzing module; and
an analyzing module receiving the defection image and analyzing the defection image for determining the type of the at least one defect according to the defection image.

8. A detecting method for a substrate, comprising:
positioning the substrate;
optically scanning the substrate to determine whether there is any defect on the substrate, and if there is at least one defect on the substrate, determining the position of the at least one defect;
obtaining size images of measuring areas of the substrate and transferring the size images; and
calculating a width of each line on the substrate and simultaneously obtaining a defection image of the at least one defect.

9. The detecting method as claimed in claim 8, wherein the step of positioning the substrate comprises: providing a plurality of positioning marks on four corners or edges of the substrate, and determining the position of the substrate relative to a detecting device according to the positions of the positioning marks on the substrate.

10. The detecting method as claimed in claim 9, wherein the step of obtaining a plurality of size images of a plurality of measuring areas and transferring the size images comprises:
an obtaining unit obtaining the size images of the measuring areas of the substrate; and
a transferring unit transferring the size images to a calculating module such that the calculating module can calculate the width of each line on the substrate.

11. The detecting method as claimed in claim 10, wherein the step of calculating the width of each line on the substrate comprises:
receiving the size images; and
calculating the width of each line of the measuring area according to the received size images and settings of the obtaining module when the size images are obtained.

12. The detecting method as claimed in claim 11, wherein the settings comprise the magnification factor between the size images and the true sizes of the measuring areas when the obtaining module obtains the size images.

13. The detecting method as claimed in claim 12, wherein the step of calculating the width of each line of the measuring areas according to the received size images and settings of the obtaining module when the size images are obtained comprises: calculating the width of each line according to the width of the line in the size images and the magnification factor.

14. The detecting method as claimed in claim 13, wherein the step of obtaining a defection image of the at least one defect, and determining the type of the at least one defect according to the defection image comprises:
the obtaining module obtaining the defection image of the at least one defect at the position of the at least one detect, and transferring the defection image to an analyzing module; and
the analyzing module receiving the defection image and analyzing the defection image for determining the type of the at least one defect according to the defection image.

15. A detecting device for a substrate, comprising:
a positioning module for positioning the substrate;
a scanning module for optically scanning the substrate, determining whether there is any defect on the substrate, and if there is at least one defect on the substrate, determining the position of the at least one defect;
an obtaining module for obtaining a plurality of size images of a plurality of measuring areas of the substrate or a defection image of the at least one defect, and transferring the size images or the defection image; and
a calculating module for calculating a width of each line on the substrate.

16. The detecting device as claimed in claim 15, wherein the obtaining module comprises an obtaining unit and a transferring unit, the obtaining unit is used for obtaining the size images of the measuring areas or the defection image of the at least one defect, and the transferring unit is used for transferring the size images or the defection image.

17. The detecting device as claimed in claim 16, wherein the calculating module is used for receiving the size images transferred from the transferring unit, and calculating the width of each line of the measuring areas according to the size images and settings of the obtaining unit when the size images are obtained.

18. The detecting device as claimed in claim 17, wherein the obtaining module comprises a first obtaining module for obtaining and transferring the size images and a second obtaining module for obtaining and transferring the defection image.

19. The detecting device as claimed in claim 18, wherein the first obtaining module comprises a first obtaining unit for obtaining the size images and a first transferring unit for transferring the size images, the second obtaining module comprises a second obtaining unit for obtaining the defection image and a second transferring unit for transferring the defection image.

20. The detecting device as claimed in claim 19 further comprising an analyzing module for determining the type of the at least one defect according to the defection image.
